(19) United States
(12) Patent Application Publication
(10) Pub. No.: US 2009/0102671 A1
(43) Pub. Date: Apr. 23, 2009

(54) Low battery alert for an image reader

(76) Inventors: Kevin Donald Susewitt, Shelby Township, MI (US); Scott Reynolds, Concord, NC (US); Richard A. Romanchik, Rochester, NY (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/975,024

(22) Filed: Oct. 17, 2007

(51) Int. Cl. G08B 21/00; G06K 7/10

(52) U.S. Cl. 340/636.1; 235/472.01

(57) ABSTRACT

A method of operating an optical reading device for collecting and processing indicia data comprising the steps of: converting light reflected from a target into output signals representative thereof utilizing an image sensor; illuminating the target utilizing an illumination source; directing light from the target to the image sensor array utilizing receive optics; decoding information contained in information bearing indicia within the target derived from the output signals utilizing a processor; powering the image sensor, illumination source, processor and display with a battery; measuring at least one parameter indicative of the battery charge; communicating charge information to an operator on a display; and housing the processor, image sensor, receive optics, illumination source and display in a common housing for hand held operation.

### FIELD OF THE INVENTION

The present invention relates to image reader devices, and more particularly to an image reader with a low battery alert.

### BACKGROUND

Indicia reading devices (also referred to as readers, readers, etc.) typically read data represented by printed indicia, (also referred to as symbols, symbology, bar codes, etc.) For instance one type of a symbol is an array of rectangular bars and spaces that are arranged in a specific way to represent elements of data in machine readable form. Optical indicia reading devices typically transmit light onto a symbol and receive light scattered and/or reflected back from a bar code symbol or indicia. The received light is interpreted by an image processor to extract the data represented by the symbol. Laser indicia reading devices typically utilize transmitted laser light.

One-dimensional (1D) optical bar code readers are characterized by reading data that is encoded along a single axis, in the widths of bars and spaces, so that such symbols can be read from a single scan along that axis, provided that the symbol is imaged with a sufficiently high resolution along that axis.

In order to allow the encoding of larger amounts of data in a single bar code symbol, a number of 1D stacked bar code symbologies have been developed which partition encoded data into multiple rows, each including a respective 1D bar code pattern, all or most all of which must be scanned and decoded, then linked together to form a complete message. Scanning still requires relatively higher resolution in one dimension only, but multiple linear scans are needed to read the whole symbol.

A class of bar code symbologies known as two dimensional (2D) matrix symbologies have been developed which offer orientation-free scanning and greater data densities and capacities than 1D symbologies. 2D matrix codes encode data as dark or light data elements within a regular polygonal matrix, accompanied by graphical finder, orientation and reference structures. Often times an optical reader may be portable and wireless in nature thereby providing added flexibility. In these circumstances, such readers form part of a wireless network in which data collected within the terminals is communicated to a host computer situated on a hardwired backbone via a wireless link. For example, the readers may include a radio or optical transceiver for communicating with a network computer.

Conventionally, a reader, whether portable or otherwise, may include a central processor which directly controls the operations of the various electrical components housed within the bar code reader. For example, the central processor controls detection of keyboard entries, display features, wireless communication functions, trigger detection, and bar code read and decode functionality.

Efforts regarding such systems have led to continuing developments to improve their versatility, practicality and efficiency.

### BRIEF DESCRIPTION OF THE DRAWINGS

FIG. 1 is a perspective view of an exemplary image reader.

FIG. 2 is a fragmentary partially cutaway side view of an exemplary image reader.

FIG. 3 is a block schematic diagram of an exemplary image reader system.

FIG. 4 is a block diagram of an exemplary indicia reader system.

FIG. 5 is a flowchart of an exemplary method of operating an image reader system.

### DETAILED DESCRIPTION

Reference will now be made to exemplary embodiments of the invention which are illustrated in the accompanying drawings. This invention, however, may be embodied in various forms and should not be construed as limited to the embodiments set forth herein. Rather, these representative embodiments are described in detail so that this disclosure will be thorough and complete, and will fully convey the scope, structure, operation, functionality, and potential of applicability of the invention to those skilled in the art. Wherever possible, the same reference numbers will be used throughout the drawings to refer to the same or like parts.

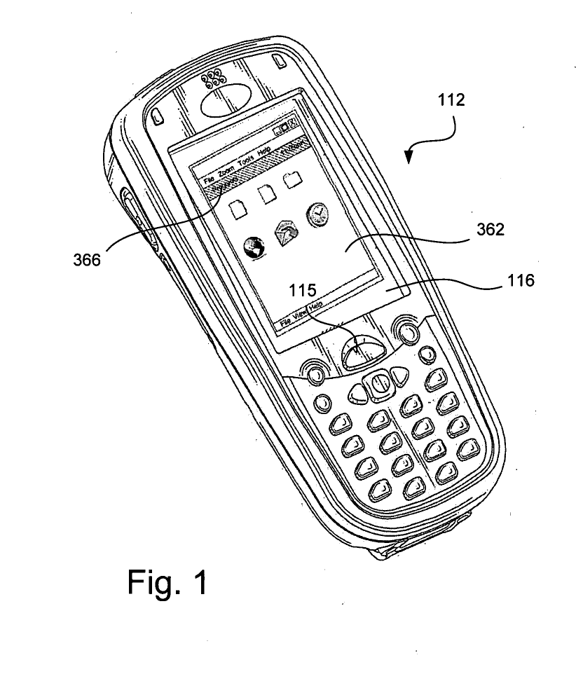

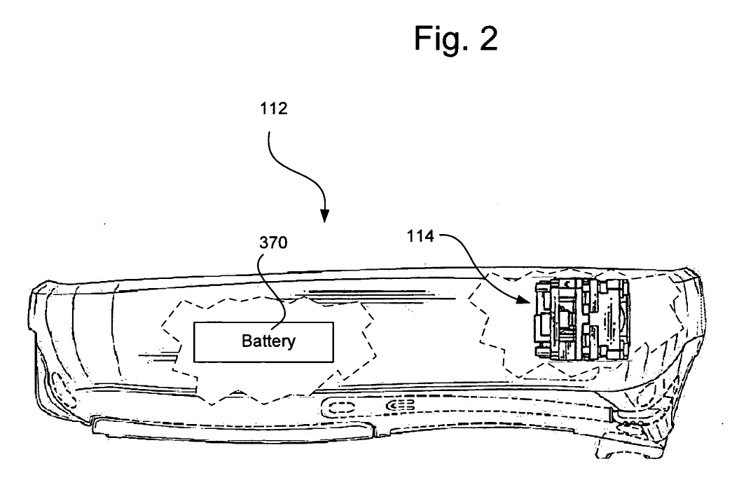

Referring to FIGS. 1 and 2, an exemplary image reading device, such as a scanner, personal digital assistant (PDA) 112, portable data terminal (PDT), scanner, etc. that may be a platform for an image reading assembly 114 having the capability for capturing and reading images, some of which may have symbol indicia provided therein. For exemplary purposes only, image reading devices will be exemplified herein in terms of PDAs, which may be typically defined as handheld devices used as a personal organizer, and having many uses such as reading information bearing indicia, calculating, use as a clock and calendar, playing computer games, accessing the Internet, sending and receiving E-mails, use as a radio or stereo, video recording, recording notes, use as an address book, and use as a spreadsheet. A plurality of buttons or keys 115 may be used to control operation of the PDA and the imaging reader assembly 114. A display 116 may be utilized to provide a user an interface for a user, such as a graphical user interface (GUI).

PDAs may be equipped with the ability to query and receive and transmit data, such as software via a communication link, such as by radio link or wired link. Upgrading firmware from host processor to PDA (also referred to as uploading or pushing) and duplicating configuration parameters may be performed by reading specific indicia to ensure PDAs are operating at the proper revision and have the proper configuration parameters.

A PDT is typically an electronic device that is used to enter or retrieve data via wireless transmission (WLAN or WWAN) and may also serve as an indicia reader used in a stores, warehouse, hospital, or in the field to access a database from a remote location.

The PDA 112 may be a Hand Held Products Dolphin® series or the like and may include a cradle connected to a computer by a cable or wireless connection to provide two-way data communication therebetween. The computer may be replaced with a different processing device, such as a data processor, a laptop computer, a modem or other connection to a network computer server, an internet connection, or the like. The PDA may include a display and keys mounted in a case to activate and control various features on the PDA. The display may be a touch screen LCD that allows the display of various icons representative of different programs available on the PDA which may be activated by finger pressure or the touch of a stylus. The display may also be used to show indicia, graphs, tabular data, animation, or the like.

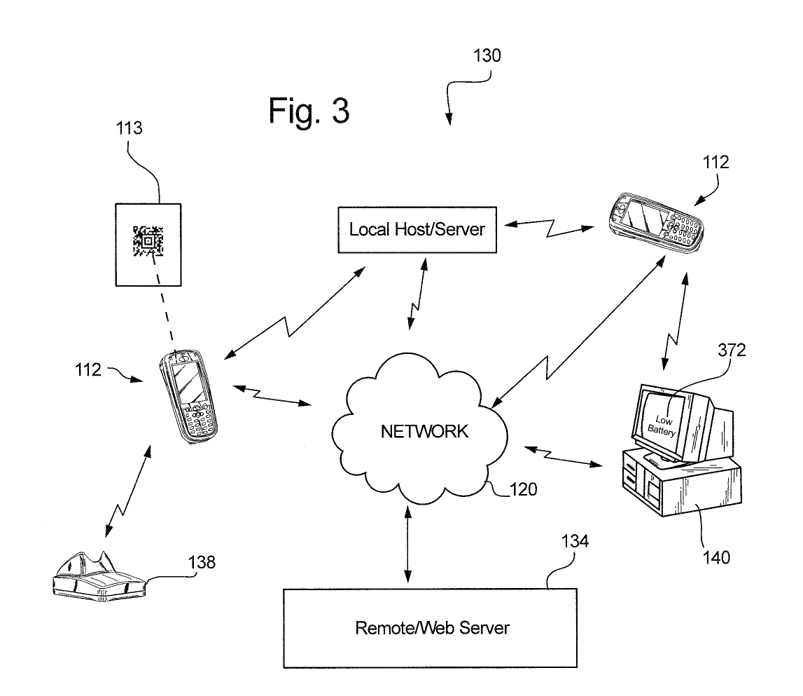

FIG. 3 illustrates a scanning system configuration in accordance with the present invention, wherein a plurality of readers 112 are being operated or utilized in a remote location, such as in a store point of sale (POS) warehouse or on a delivery truck. A reader may be in communication (wired or wireless) with the internet through the use of a local processing system 130, such as might be resident on a local server or computer having a wired or wireless router for providing internet service to a device or devices such as PDAs. The local processing system 130 may be in communication via the internet with a remote/web server 134 through a wired or wireless connection for the transfer of information over a distance without the use of electrical conductors or “wires”. The distances involved may be short (a few meters as in television remote control) or very long (thousands or even millions of kilometers for radio communications). Wireless communication may involve radio frequency communication. Applications may involve point-to-point communication, point-to-multipoint communication, broadcasting, cellular networks and other wireless networks. This may involve: cordless telephony such as DECT (Digital Enhanced Cordless Telecommunications); Cellular systems such as 0G, 1G, 2G, 3G or 4G; Short-range point-to-point communication such as IrDA or RFID (Radio Frequency Identification), Wireless USB, DSRC (Dedicated Short Range Communications); Wireless sensor networks such as ZigBee; Personal area networks such as Bluetooth or Ultra-wideband (UWB from WiMedia Alliance); Wireless computer networks such as Wireless Local Area Networks (WLAN), IEEE 802.11 branded as WiFi or HIPERLAN; or Wireless Metropolitan Area Networks (WMAN) and Broadband Fixed Access (BWA) such as LMDS, WiMAX or HIPERMAN.

The Internet is the worldwide, publicly accessible network of interconnected computer networks that transmit data by packet switching using the standard Internet Protocol (IP). It is a “network of networks” that consists of millions of smaller domestic, academic, business, and government networks, which together carry various information and services, such as electronic mail, online chat, file transfer, and the interlinked Web pages and other documents of the World Wide Web. The IP is a data-oriented protocol used for communicating data across a packet-switched internetwork, and may be a network layer protocol in the internet protocol suite and encapsulated in a data link layer protocol (e.g., Ethernet). As a lower layer protocol, the IP provides the service of communicable unique global addressing amongst computers to provide a service not necessarily available with a data link layer.

Ethernet provides globally unique addresses and may not be globally communicable (i.e., two arbitrarily chosen Ethernet devices will only be able to communicate if they are on the same bus). IP provides final destinations with data packets whereas Ethernet may only be concerned with the next device (computer, router, etc.) in the chain. The final destination and next device could be one and the same (if they are on the same bus) but the final destination could be remotely located. IP can be used over a heterogeneous network (i.e., a network connecting two computers can be any mix of Ethernet, ATM, FDDI, Wi-fi, token ring, etc.) and does not necessarily affect upper layer protocols.

One or more PDA may be outfitted with a communication module configured to communicate with other PDAs that have an appropriate type communication module. One or more PDA may be configured to communicate with a base unit 138 configured to interface between the PDA and a network.

In the case of a mobile hand held optical PDA hardwired to its individual base unit, this link between the PDA and base unit is fixed and permanent. In the case of a wireless mobile hand held optical PDA that communicates wirelessly with its individual base unit, this link can be made by programming the PDA with information identifying the particular base unit so the PDA directs its transmitted information to that base unit, or vice versa.

One or more readers 112 may be in communication (wired or wireless) with a local point of sale register 140. The local point of sale register 140 may be in communication via a wired or wireless connection for the transfer of information over a distance without the use of electrical conductors or “wires”.

The information bearing indicia may be displayed on and read from an exemplary display, such as may be disposed on a platform such as PC monitor, mobile phone, portable data terminal (PDT), personal digital assistant (PDA), etc. A Portable Data Terminal, or PDT, is typically an electronic device that is used to enter or retrieve data via wireless transmission (WLAN or WWAN) and may also serve as an indicia reader used in a stores, warehouse, hospital, or in the field to access a database from a remote location. The information bearing indicia may also be printed on a printable medium 113, such as a product, packaging, etc. and then read by the reader. This would allow for users to receive a “software or firmware update” barcode electronically (i.e. email) and then simply view and scan the barcode on the PC.

In the exemplary embodiment, software or firmware installation may be completed by a user simply by access to a wired or wireless connection to a host server.

The terms “scan”, “scanning” or “reading” use herein refers to reading or extracting data from an information bearing indicia (IBI), barcode or symbol.

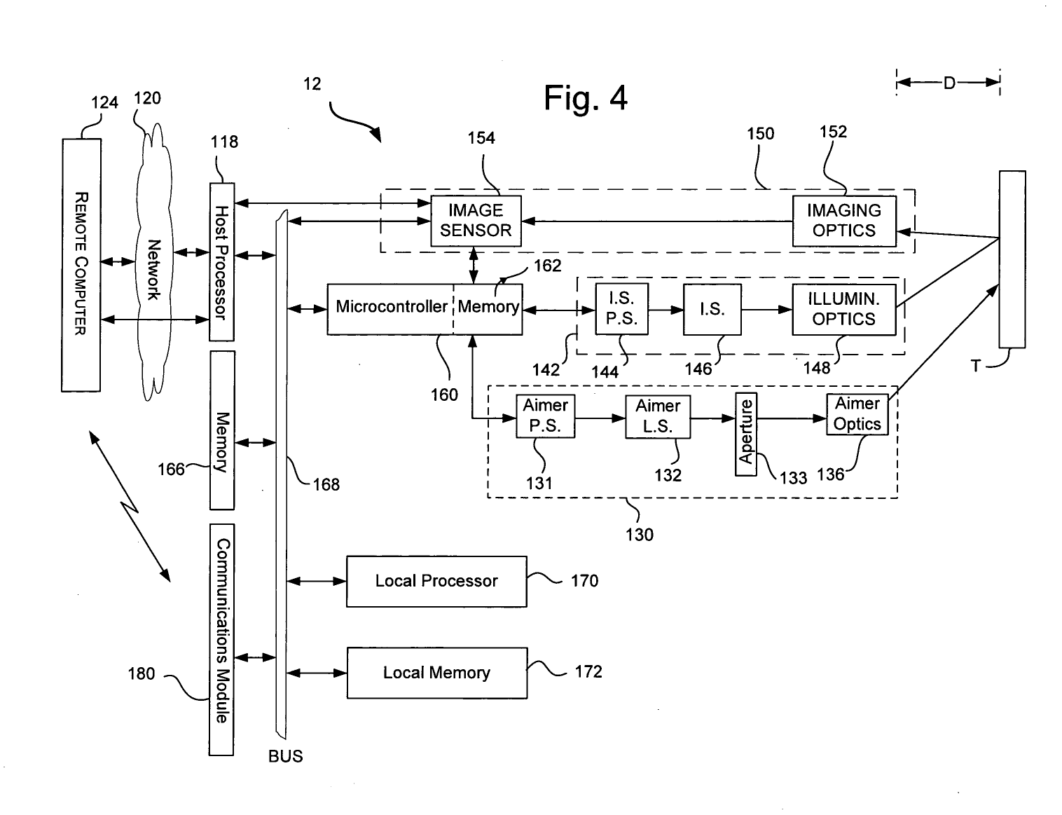

Referring to FIGS. 2 and 4, an optical indicia reader 112 may have a number of subsystems for capturing and reading images, some of which may have symbol indicia provided therein. Reader 112 may have an imaging reader assembly 114 provided within a head portion or housing 116 which may be configured to be hand held by an operator. A trigger 115 may be used to control operation of the reader 112. Image reader assembly 114 has imaging receive optics 152 having an optical axis (OA) for receiving light reflected from a target T and directing or projecting the reflected light from the target T to an image sensor 154. The optical axis is a line of symmetry through the imaging optics.

The receive optics 152 has a focal point wherein parallel rays of light coming from infinity converge at the focal point. If the focal point is coincident with the image sensor, the target (at infinity) is “in focus”. A target T is said to be in focus if light from target points are converged about as well as desirable at the image sensor. Conversely, it is out of focus if light is not well converged. “Focusing” is the procedure of adjusting the distance between the receive optics and the image sensor to cause the target T to be approximately in focus.

The target may be any object or substrate and may bear a 1D or 2D bar code symbol or text or other machine readable indicia. A trigger 115 may be used for controlling full or partial operation of the reader 112.

Image sensor 154 may be a two-dimensional array of pixels adapted to operate in a global shutter or full frame operating mode which is a color or monochrome 2D CCD, CMOS, NMOS, PMOS, CID, CMD, etc. solid state image sensor. This sensor contains an array of light sensitive photodiodes (or pixels) that convert incident light energy into electric charge. Solid state image sensors allow regions of a full frame of image data to be addressed. An exemplary CMOS sensor is model number MT9V022 from Micron Technology Inc. or model number VC5602V036 36CLCC from STMicroelectronics.

Further description of image sensor operation is provided in commonly owned U.S. patent application Ser. No. 11/077,995 entitled “BAR CODE READING DEVICE WITH GLOBAL ELECTRONIC SHUTTER CONTROL” filed on Mar. 11, 2005, which is hereby incorporated herein by reference in it's entirety.

In a full frame (or global) shutter operating mode, the entire imager is reset before integration to remove any residual signal in the photodiodes. The photodiodes (pixels) then accumulate charge for some period of time (exposure period), with the light collection starting and ending at about the same time for all pixels. At the end of the integration period (time during which light is collected), all charges are simultaneously transferred to light shielded areas of the sensor.

The light shield prevents further accumulation of charge during the readout process. The signals are then shifted out of the light shielded areas of the sensor and read out.

Features and advantages associated with incorporating a color image sensor in an imaging device, and other control features which may be incorporated in a control circuit are discussed in greater detail in U.S. Pat. No. 6,832,725 entitled “An Optical Reader Having a Color Imager” incorporated herein by reference. It is to be noted that the image sensor 154 may read images with illumination from a source other than illumination source 146, such as by illumination from a source located remote from the reader.

The output of the image sensor may be processed utilizing one or more functions or algorithms to condition the signal appropriately for use in further processing downstream, including being digitized to provide a digitized image of target T. Microcontroller 160 may perform a number of functions. The particulars of the functionality of microcontroller 160 may be determined by or based upon certain configuration settings or data which may be stored in remote or local memory or firmware 162, 166, 172. One such function may be controlling the amount of illumination provided by illumination source 146 by controlling the output power provided by illumination source power supply 144. Microcontroller 160 may also control other functions and devices.

An exemplary microcontroller 160 is a CY8C24223A made by Cypress Semiconductor Corporation, which is a mixed-signal array with on-chip controller devices designed to replace multiple traditional MCU-based system components with one single-chip programmable device. It may include configurable blocks of analog and digital logic, as well as programmable interconnects.

Microcontroller 160 may include a predetermined amount of memory 162 for storing firmware and data. The firmware may be a software program or set of instructions embedded in or programmed on the microcontroller which provides the necessary instructions for how the microcontroller operates and communicates with other hardware. The firmware may be stored in the flash memory (ROM) of the microcontroller as a binary image file and may be erased and rewritten. The firmware may be considered “semi-permanent” since it remains the same unless it is updated. This firmware update or load may be handled by a device driver.

The components in reader 112 may be connected by one or more bus 168, data lines or other signal or data communication form. Exemplary forms may be an Inter-IC bus such as an I²C bus, dedicated data bud, RS232 interface, etc. An I²C bus is a control bus that provides a communications link between integrated circuits in a system. This bus may connect to a host computer in relatively close proximity, on or off the same printed circuit board as used by the imaging device. I²C is a two-wire serial bus with a software-defined protocol and may be used to link such diverse components as the image sensor 154, temperature sensors, voltage level translators, EEPROMs, general-purpose I/O, A/D and D/A converters, CODECs, and microprocessors/microcontrollers. A host processor 118 or a local processor 170 may be utilized to perform a number of functional operation, which may involve the performance of a number of related steps, the particulars of which may be determined by or based upon certain configuration settings stored in memory 166 which may be any one of a number of memory types such as RAM, ROM, EEPROM, etc. In addition some memory functions may be stored in memory 162 provided as part of the microcontroller 160.

An exemplary function of a processor 118, 170 may be to decode machine readable symbology or information bearing indicia (IBI) provided within the target or captured image, such as one dimensional symbologies which may include very large to ultra-small, Code 128, Interleaved 2 of 5, Codabar, Code 93, Code 11, Code 39, UPC, EAN, and MSI. Stacked 1D symbologies may include PDF, Code 16K and Code 49. 2D symbologies may include Aztec, Datamatrix, Maxicode, and QR-code. UPC/EAN symbology or barcodes are standardly used to mark retail products throughout North America, Europe and several other countries throughout the worlds. Decoding is a term used to describe the interpretation of a machine readable code contained in an image captured by the image sensor 154. The code has data or information encoded therein. Information respecting various reference decode algorithm is available from various published standards, such as by the International Standards Organization (“ISO”).

An exemplary function of host processor 118, 170 may be to manipulate images, such as cropping or rotation such as described herein. Imaging reader assembly 112 may also have an aiming generator light source 132, aiming aperture 133, aiming optics 136, an illumination source(s) 146 and illumination optics 148.

Illumination and aiming light sources with different colors may be employed. For example, in one such embodiment the image reader may include white and red LEDs, red and green LEDs, white, red, and green LEDs, or some other combination chosen in response to, for example, the color of the symbols most commonly imaged by the image reader. Different colored LEDs may be each alternatively pulsed at a level in accordance with an overall power budget. Aiming pattern generator 130 may include a power supply 131, light source 132, aperture 133 and optics 136 to create an aiming light pattern projected on or near the target which spans a portion of the receive optical system 150 operational field of view with the intent of assisting the operator to properly aim the scanner at the bar code pattern that is to be read. A number of representative generated aiming patterns are possible and not limited to any particular pattern or type of pattern, such as any combination of rectilinear, linear, circular, elliptical, etc. figures, whether continuous or discontinuous, i.e., defined by sets of discrete dots, dashes and the like.

Generally, the aiming light source may comprise any light source which is sufficiently small or concise and bright to provide a desired illumination pattern at the target. For example, light source 132 for aiming generator 130 may comprise one or more LEDs 134, such as part number NSPG300A made by Nichia Corporation.

The light beam from the LEDs 132 may be directed towards an aperture 133 located in close proximity to the LEDs. An image of this back illuminated aperture 133 may then be projected out towards the target location with a lens 136. Lens 136 may be a spherically symmetric lens, an aspheric lens, a cylindrical lens or an anamorphic lens with two different radii of curvature on their orthogonal lens axis. Alternately, the aimer pattern generator may be a laser pattern generator. The light sources 132 may also be comprised of one or more laser diodes such as those available from Rohm. In this case a laser collimation lens (not shown in these drawings) will focus the laser light to a spot generally forward of the scanning hear and approximately at the plane of the target T. This beam may then be imaged through a diffractive interference pattern generating element, such as a holographic element fabricated with the desired pattern in mind. Examples of these types of elements are known, commercially available items and may be purchased, for example, from Digital Optics Corp. of Charlotte, N.C. among others. Elements of some of these types and methods for making them are also described in U.S. Pat. Nos. 4,895,790 (Swanson); 5,170,269 (Lin et al) and 5,202,775 (Feldman et al), which are hereby incorporated herein by reference.

Image reader may include an illumination assembly 142 for illuminating target area T. Illumination assembly 142 may also include one or more power supplies 144, illumination sources 146 and illumination optics 148.

A communications module 180 provides a communication link from imaging reader 112 to other imaging readers or to other systems such as a server/remote processor 124.

The processor, memory and associated circuitry which performs or controls the exemplary image manipulations (e.g. image cropping function) described hereinbefore may be provided in the image reader assembly 114 or on associated circuit boards which are located within the housing 116 of the image reader 112.

A battery 370 may be used for powering the electronics of the reader 112. Sometimes an operator will neglect to properly maintain battery charge on a wireless image reader and doing so may cause excessive down time. An exemplary embodiment is to provide a PDA with a configurable, stealthy software program that monitors the charge level of a battery at predetermined intervals, and if certain conditions are met, produces audio and/or visual alerts. Both features may run independently of each other and may be enabled or disabled.

An exemplary reader may have a battery alert software program can be loaded on the Image reader, which may periodically monitor the charged state of the battery. When certain predefined declining levels of battery charge are detected, the program may for example cause the reader to change the colors schemes of the running programs by applying different desktop themes (e.g. Green, Yellow, Red). An additional exemplary feature provides for the image reader to generate an audible tone if the battery charge level falls below a predetermined value.

The image reader may send a message 372 to an exemplary host or remote device, such as a server or cash register at the point of sale that the battery is low or is about to fail. Messages for other potentially problematic situations may also be sent to the cash register. The cash register may then display a message to the operator at the point of sale that the scanner has a low battery or other problematic condition is occurring. The low battery communication may be made utilizing the same protocol or method or interface as that used to transmit indicia data. The low battery communication may be made via a wired communication link also, such as a serial connection.

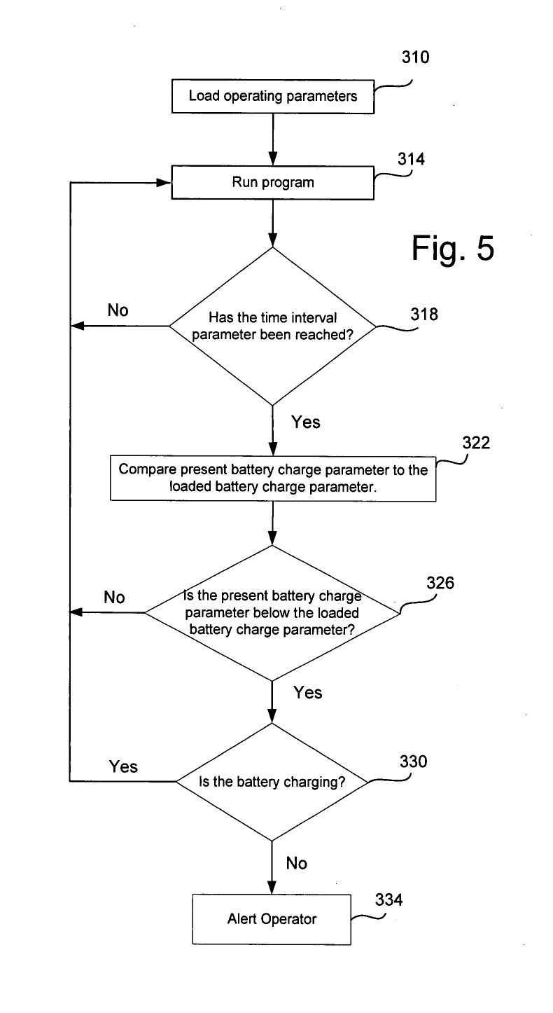

Referring to FIG. 5, an exemplary software program for operating an image reader is to load operating parameters in a step 310. Exemplary parameters may be the time interval between battery level tests, battery level comparisons, low battery level warning limits, alert tone, alert pitch and, alert duration, alert color, etc. The program is run in a step 314, and may be run in the background of other programs or functions. In a step 318, a query is made if a time interval parameter or limit has been reached. If not, the program continues to run. If the time interval parameter has been met, the present battery charge parameter is compared to the loaded or predetermined battery charge parameter in a step 322. A query is made in a step 326 whether the present battery charge parameter is below the loaded or predetermined battery charge parameter. If no, the program continues to run. If yes, a query is made in a step 330 whether the battery is charging. If the battery is charging, the program continues to run. If the battery is not charging, the operator is alerted in a step 334.

Referring to FIG. 1, an exemplary image reading device 112 may have a display 116 on which a graphical user interface (GUI) 362 may be displayed. A GUI may be a type of user interface which allows operators to interact with an image reading device or other computer-controlled devices which may employ graphical icons, visual indicators or special graphical elements along with text, labels or text navigation to represent the information and actions available to the operator. The actions may be performed through direct manipulation of the graphical elements. A part 366 of the GUI may be color coded to reflect or indicate a battery charge parameter to provide feedback to the operator. For example, the part may be a bar on the GUI which is green when the battery is at full charge, yellow when the battery is at half charge and red when the battery is at low charge.

What is described herein is an exemplary method of operating an optical reading device for collecting and processing indicia data comprising the steps of: converting light reflected from a target into output signals representative thereof utilizing an image sensor; illuminating the target utilizing an illumination source; directing light from the target to the image sensor array utilizing receive optics; decoding information contained in information bearing indicia within the target derived from the output signals utilizing a processor; powering the image sensor, illumination source, processor and display with a battery; measuring at least one parameter indicative of the battery charge; communicating charge information to an operator on a display; and housing the processor, image sensor, receive optics, illumination source and display in a common housing for hand held operation.

In an exemplary embodiment, the measured battery parameters are compared with predetermined parameter limits and wherein communicating comprises communicating the comparison results information to the operator.

In an exemplary embodiment, the communicating charge information comprises changing a color on at least part of the display.

In an exemplary embodiment, changing color comprises providing more than one color change in response to the battery charge meeting predetermined parameter limits.

In an exemplary embodiment, the communicating charge information comprises broadcasting an audible tone.

In an exemplary embodiment, a graphical user interface is provided on the display.

In an exemplary embodiment, the battery charge parameter comprises a battery charge percent.

In an exemplary embodiment, communicating charge information comprises sending a message to a remote point of sale display.

In an exemplary embodiment, sending a message to a remote point of sale display comprises at least one of the following: changing a color on at least part of the remote point of sale display; creating a text message; and broadcasting an audible tone.

In an exemplary embodiment, a set of parameters or values may be utilized when the battery is charging, and may indicate the charging progress. For example, the indication to the operator may be to turn a portion or part of the GUI green only after a charge of 95% of full charge or battery capacity is reached.

In an exemplary embodiment, a red GUI theme may be set if the battery is charging and stay red until a battery parameter value is reached and then the GUI may switch to a green theme.

It should be understood that the programs, processes, methods and apparatus described herein are not related or limited to any particular type of computer or network apparatus (hardware or software). Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa. The illustrated embodiments are exemplary only, and should not be taken as limiting the scope of the present invention. For example, the steps of the flow diagrams may be taken in sequences other than those described, and more, fewer or other elements may be used in the block diagrams. Also, unless applicants have expressly disavowed any subject matter within this application, no particular embodiment or subject matter is considered to be disavowed herein.

1. A method of operating an optical reading device for collecting and processing indicia data comprising the steps of:
converting light reflected from a target into output signals representative thereof utilizing an image sensor;
illuminating the target utilizing an illumination source;
directing light from the target to the image sensor array utilizing receive optics;
decoding information contained in information bearing indicia within the target derived from the output signals utilizing a processor;
powering the image sensor, illumination source, processor and display with a battery;
measuring at least one parameter indicative of the battery charge;
communicating charge information to an operator on a display; and
housing the processor, image sensor, receive optics, illumination source and display in a common housing for hand held operation.

2. A method according to claim 1, further comprising comparing the measured battery parameters with predetermined parameter limits and wherein communicating comprises communicating the comparison results information to the operator.

3. A method according to claim 1, wherein communicating charge information comprises changing a color on at least part of the display.

4. A method according to claim 3, wherein the changing a color comprises providing more than one color change in response to the battery charge meeting predetermined parameter limits.

5. A method according to claim 1, wherein communicating charge information comprises broadcasting an audible tone.

6. A method according to claim 1, wherein a graphical user interface is provided on the display.

7. A method according to claim 1, wherein the parameter comprises a battery charge percent.

8. A method according to claim 1, wherein communicating charge information comprises sending a message to a remote point of sale display.

9. A method according to claim 8, wherein sending a message to a remote point of sale display comprises at least one of the following: changing a color on at least part of the remote point of sale display; creating a text message; and broadcasting an audible tone.

10. A method according to claim 1, further comprising the step of determining whether the battery is charging.

11. An optical reading device for collecting and processing indicia data comprising:
an image sensor for converting light reflected from a target into output signals representative thereof;
an illumination source for illuminating the target;
receive optics for directing light from the target to the image sensor array;
a processor for decoding information contained in information bearing indicia within the target derived from the output signals;
a battery for powering the image sensor, illumination source, processor and display;
a housing for housing the processor, image sensor, receive optics, illumination source and display for hand held operation;
wherein the processor measures at least one parameter indicative of the battery charge and communicates charge information to an operator on a display.

12. An optical reading device according to claim 11, wherein the processor compares the measured battery parameters with predetermined parameter limits and communicates the comparison results information to the operator.

13. An optical reading device according to claim 11, wherein the processor communicates charge information by changing a color on at least part of the display.

14. An optical reading device according to claim 13, wherein the changing a color comprises providing more than one color change in response to the battery charge meeting predetermined parameter limits.

15. An optical reading device according to claim 11, wherein communicating charge information comprises broadcasting an audible tone.

16. An optical reading device according to claim 11, wherein the display comprises a graphical user interface.

17. An optical reading device according to claim 11, wherein the parameter comprises a battery charge percent.

18. An optical reading device according to claim 11, wherein communicating charge information comprises sending a message to a remote point of sale display.

19. An optical reading device according to claim 18, wherein sending a message to a remote point of sale display comprises at least one of the following: changing a color on at least part of the remote point of sale display; creating a text message; and broadcasting an audible tone.
